(19) United States
(12) Patent Application Publication
(10) Pub. No.: US 2026/0055540 A1
(43) Pub. Date: Feb. 26, 2026

(54) ON-LINE CRIMP CONTROL AND MEASUREMENT FOR TOW

(71) Applicant: Acetate International LLC, Irving, TX (US)

(72) Inventors: Sander Vandenbon, Hasselt (BE); Philip Caenen, Lanaken (BE)

(73) Assignee: Acetate International LLC, Irving, TX (US)

(21) Appl. No.: 19/305,485

(22) Filed: Aug. 20, 2025

Related U.S. Application Data
(60) Provisional application No. 63/685,549, filed on Aug. 21, 2024.

(51) Int. Cl. D02G 1/12; D01D 5/06; G01N 21/89

(52) U.S. Cl. CPC D02G 1/125; D01D 5/06; G01N 21/8915

(57) ABSTRACT

Disclosed are improved methods for crimping tow and/or measuring the crimp of the tow (e.g., the crimp level and/or uncrimp energy). Also disclosed is tow produced using such methods. The methods can result in tow (e.g., cellulose acetate tow) that has more consistent and precise crimp than has been previously achieved.

### CROSS-REFERENCE TO RELATED APPLICATIONS

This Application claims priority to U.S. Provisional Application No. 63/685,549, filed on Aug. 21, 2024, the entire contents and disclosures of which are incorporated by reference herein.

### FIELD OF THE INVENTION

The present disclosure relates generally to improved methods for crimping tow and/or measuring the crimp of the tow (e.g., the crimp level and/or the uncrimp energy). The present disclosure can also relate to tow prepared using either or both of such methods. The methods can result in tow (e.g., cellulose acetate tow) that has more consistent and precise crimp than has been previously achieved.

### BACKGROUND OF THE INVENTION

Cellulose esters such as cellulose acetate are known for their robust uses, especially as filaments and fibers. Indeed, cellulose acetate is one of the principal types of synthetic fibers. As interest in the materials increases, the availability of high-quality cellulose acetate with consistent properties is desirable.

For example, crimp is a waviness imparted to synthetic fibers during manufacture and crimp level may traditionally be measured as uncrimp energy (UCE). UCE uniformity for cellulose acetate is an important parameter downstream affecting pressure drop variability on a filter rod of cellulose acetate. Put simply, the UCE is the amount of work required to uncrimp a fiber. Thus, UCE is the area under the load-elongation curve between defined load limits, per unit length of extended sample (at the upper load limit). Traditionally, the uncrimp energy (UCE) of cellulose acetate is measured manually with a destructive test. Thus, UCE has traditionally been measured as follows: using a warmed up (20 minutes before conventional calibration) Instron tensile tester (Model 1130, crosshead gears—Gear #'s R1940-1 and R940-2, Instron Series IX-Version 6 data acquisition & analysis software, Instron 50 Kg maximum capacity load cell, Instron top roller assembly, 1″×4″×⅛″ thick high grade Buna-N 70 Shore A durometer rubber grip faces), a preconditioned tow sample (preconditioned for 24 hours at 22° C.±2° C. and Relative humidity at 60%±2%) of about 76 cm in length is looped over and spread evenly across the center of the top roller, pre-tensioned by gently pulling to 100 g±2 g (per readout display), and each end of the sample is clamped (at the highest available pressure, but not exceeding the manufacturers recommendations) in the lower grips to effect a 50 cm gauge length (gauge length measured from top of the robber grips), and then tested, until break, at a crosshead speed of 30 cm/minute. This test is repeated until three acceptable tests are obtained and the average of the three data points from these tests is reported. UCE is calculated by the formula: UCE (gcm/cm)=(E*1000)/((D*2)+500). Energy (E) is in units of mm·kgf and displacement is in units of mm. Energy (E) is the integrated area beneath the load-elongation curve between the load limits (e.g., 0.220 kg and 10 kg). Displacement (D) is the distance the top roller (or Instron x-head) moves from the starting position to that at the 10 kg load, for example. In should be noted that for a conventional total denier, a 10 kg upper load limit is typically used. However, for high dpf, low total denier tow bands, a 6 kg load limit can be used to define UCE parameters, for example. Breaking strength can be calculated using the same test and the following equation BS=L (where L is the load at max load (kg)). In certain embodiments of the invention, UCE values (in gcm/cm) can range from 30 to 400, e.g., 50 to 400, 50 to 300, 100, to 300, 200 to 300, e.g., 290. In certain embodiments of the invention, breaking strength can range from between 3.5 kg and 25 kg, e.g. 4 kg to 20 kg, 4.5 kg to 15 kg, or 5 kg to 12 kg.

However, such methods are time-consuming and require using and destroying cellulose acetate samples for the testing process. Therefore, the need exists for improved methods for better crimp level and UCE uniformity along with faster, accurate methods for measuring the crimp level and/or UCE in a non-destructive manner.

### SUMMARY OF THE INVENTION

In some aspects, the present disclosure relates to a method for measuring the crimp level and/or the uncrimp energy for a tow, the method comprising: providing a tow band; illuminating the tow band with at least one light; capturing at least one image of the light reflecting off the tow band; and analyzing the image to determine the crimp level and/or the uncrimp energy for the tow band. The tow can comprise cellulose acetate, for example. In some embodiments, the at least one light can be a visible light. In other embodiments, the at least one light is not a visible light, for example an infrared or an ultraviolet light. In some embodiments, analyzing the image to determine the crimp level and/or the uncrimp energy for the tow band involves analyzing using computer software. In some embodiments, the source of the at least one light is at a distance of less than 20 meters from the tow band (e.g., from 1 cm to 10 meters). In some, but not all, embodiments, analyzing the image to determine the crimp level and/or the uncrimp energy for the tow band can comprise isolating a color channel of the image. In some cases, the above method can be performed after the tow has been crimped and/or dried. In some embodiments, the above method is carried out before forming the tow into layers or bales.

Some embodiments of the disclosure involve a process for making a cellulose acetate tow comprising the steps of: spinning a dope comprising a solution of cellulose acetate and a solvent; taking-up the spun cellulose acetate filaments; forming a tow from the cellulose acetate filaments; plasticizing the tow; crimping the plasticized tow; drying the crimped tow; illuminating the tow band with at least one light; capturing at least one image of the light reflecting off the tow band; and analyzing the image to determine the crimp level and/or the uncrimp energy for the tow band; and baling the dried crimped tow. In some embodiments, the at least one light can be a visible light. In other embodiments, the at least one light is not a visible light, for example an infrared or an ultraviolet light. In some embodiments, analyzing the image to determine the crimp level and/or the uncrimp energy for the tow band involves analyzing the image using computer software. In some, but not all, embodiments, analyzing the image to determine the crimp level and/or the uncrimp energy for the tow band can comprise isolating a color channel of the image. By using the methods described herein, the cellulose acetate product can have less variability compared to cellulose acetate tow using convention methods.

### BRIEF DESCRIPTION OF THE DRAWINGS

The present invention will be better understood in view of the appended non-limiting figure, in which:

FIG. 1 is a schematic illustration of a cigarette tow production process according to the present disclosure.

FIG. 2 is a side elevational view of a stuffer box crimper as part of the tow production process, parts broken away for clarity.

FIG. 3 is a top plan view of the stuffer box crimper in FIG. 2, parts broken away for clarity.

FIG. 4 is a front elevational detail view of the entry area of the stuffer box crimper in FIG. 2, parts broken away for clarity.

FIG. 5A is an illustration of a moving coil voice coil actuator.

FIG. 5B is an illustration of a moving magnet voice coil actuator.

### DETAILED DESCRIPTION OF THE INVENTION

### I. Introduction

The present disclosure is directed to improved methods for crimping tow and measuring and/or predicting the crimp of the tow (e.g., the crimp level and/or the uncrimp energy), for example cellulose acetate tow. The present disclosure can also relate to tow prepared using such methods. The methods can result in tow (e.g., cellulose acetate tow) that has more consistent and precise crimp, for example as determined by measuring and/or predicting the crimp level and/or the uncrimp energy (UCE), than has been previously achieved.

As noted, cellulose acetate was previously tested manually to determine the UCE using destructive testing. Such methods are time-consuming and can lead to inconsistencies dependent on the frequency of testing and the personnel involved. In addition, only select samples of the tow are typically tested, not the entirety of the tow product. The present invention, however, takes a different approach by using improved techniques to introduce consistent crimp and/or to determine the crimp level and/or the uncrimp energy for the tow band.

The method for introducing consistent crimp can involve precise control of a stuffer box flapper in a tow manufacturing process, using an apparatus capable of applying pressure operatively coupled to the flapper, for example (e.g., a voice coil actuator or a proportional valve controller). The method for determining the crimp level and/or the uncrimp energy for the tow band can involve illuminating tow, such as in the form of a tow band, with light. Embodiments can involve capturing and/or analyzing an image of the light illuminating or reflecting off of the tow band to determine the crimp level and/or the UCE of the tow.

### II. Process for Making Cellulose Ester

In general, tow (e.g., tow for cigarettes or for aerosol-generating devices) is made by spinning a dope into a plurality of filaments, taking up the filaments, lubricating the filaments, forming a tow by bundling a plurality of the filaments, crimping the tow, drying the crimped tow, and baling the dried crimped tow.

### Cellulose Ester

A dope is a solution of the polymer and solvent. The preferred polymer is cellulose acetate and the preferred solvent is acetone. The cellulose can be exhaustively acetylated with the acetylating agent to produce a derivatized cellulose having a high degree of substitution (DS) value. Cellulose acetate suitable for use in as cigarette or aerosol-generating device filter material can have a degree of substitution of less than 3.0, preferably in the range of 2.2 to 2.8, and most preferably in the range of 2.4 to 2.6, for example.

In some embodiments, the filaments can range from 1 to 40 denier per filament (dpf) (e.g., from 1 dpf to 35 dpf, from 3 dpf to 35 dpf, from 5 dpf to 35 dpf, from 5 dpf to 30 dpf, from 10 dpf to 30 dpf, from 10 dpf to 25 dpf, from 12 dpf to 25 dpf, or from 10 dpf to 20 dpf), for example. In some embodiments, the filaments can have a dpf of less than 12.5 (e.g., from 1 to 12.4, from 5 to 12, from 6 to 12, or from 8 to 12). The filaments may have any cross-sectional shape, including, but not limited to, circular, crenulated, Y, X, and dogbone. In some embodiments, the tow ranges from 1,000 to 100,000 total denier (e.g., from 1,000 to 50,000 total denier, from 2,000 to 30,000 total denier, from 2,000 to 25,000 total denier, from 2,000 to 20,000 total denier, from 2,000 to 15,000 total denier, from 2,000 to 10,000 total denier, from 2,000 to 8,000 total denier, or from 3,000 to 7,000 total denier). In some embodiments, the tow has a width (lateral edge to lateral edge) of less than 3 inches (8 cm) exiting the crimper.

### Tow Production Process

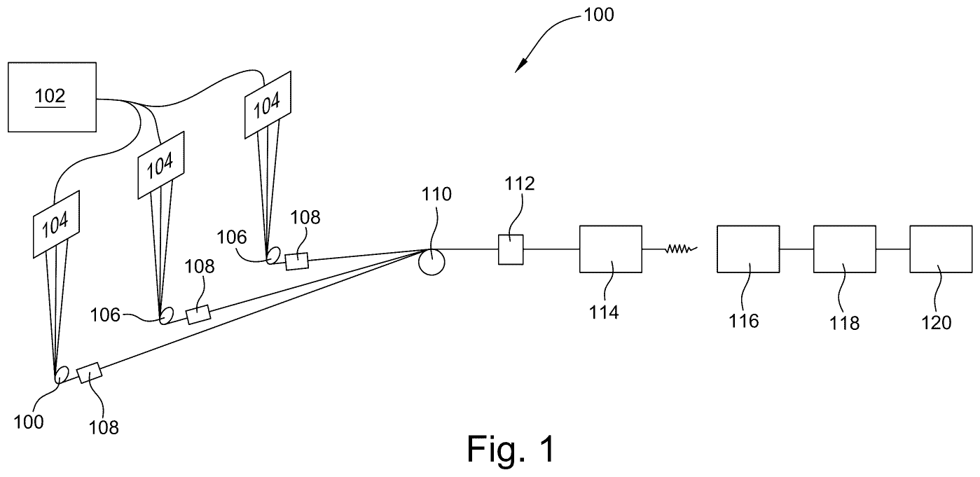

FIG. 1 shows an example of a tow production process 100 (e.g., a cigarette tow or a tow for aerosol-generating devices). Dope preparation station 102 feeds a plurality of cabinets 104 (only three shown, without being limited). In cabinets 104, fibers are produced. The fibers are taken-up on take-up roller 106. These fibers are lubricated at a lubrication station 108 with a finish (discussed in greater detail below). These lubricated fibers are bundled together to form a tow on a roller 110. The tow is plasticized at a plasticizing station 112 (discussed in greater detail below). The tow is then passed through a crimper 114 (discussed in greater detail below). The improved methods for crimping the tow are described below. The crimped tow is dried in dryer 116. In some embodiments, the dried tow can be measured for crimp level and/or UCE at station 118. The improved methods for measuring the crimp level and/or uncrimp energy of the tow can, in some embodiments, occur at this stage and are described below. The dried crimped tow is then baled at baling station 120. Although the tow crimp level and/or UCE measurement is shown between the dryer 116 and the baling station 120 in this embodiment, the tow crimp level and/or UCE measurement can also or alternatively be performed at different points in the process.

### Filter Rods

Filter rods (e.g., for cigarettes or for aerosol-generating devices) can be made by de-baling and opening the tow and running the open tow through a rodmaking machine. In the rodmaker, the tow is opened or “bloomed,” formed into a rod. In the case of cigarettes, it is wrapped with paper, referred to as plugwrap. The filter rod is subsequently cut to a specified length and attached to a cigarette or used in an aerosol-generating device, for example. The use of the tow in aerosol-generating devices, either as a conventional filter or as a porous mass is described in U.S. Pub. No. 2019/0090533, herein incorporated by reference.

While the instant invention is directed primarily to methods for making cellulose acetate tow with more uniform crimp level or the UCE and the on-line measurement of crimp level or UCE for cellulose acetate tow, the invention may also be used in the production of any spinnable polymer. Such spinnable polymers include, but are not limited to, polyolefins, polyamides, polyesters, cellulose esters and ethers and their derivatives, polylactic acid (PLA), and the like.

### Lubricant

In some embodiments, the lubricant (or finish) applied to the fibers at the first lubrication station 108 comprises: mineral oil, emulsifiers, and water. The mineral oil can be a liquid petroleum derivative, for example. The preferred mineral oil is a water white (i.e., clear) mineral oil. In some embodiments involving mineral oils, the mineral oil can have a viscosity of 80-95 SUS (Sabolt Universal Seconds) measured at 100° F. The emulsifiers are preferably a mixture of emulsifiers. The preferred mixture of emulsifiers comprises sorbitan monolaurate and POE 20 sorbitan monolaurate. The water is preferably de-mineralized water, de-ionized water, or otherwise appropriately filtered and treated water. In some embodiments, the lubricant may consist of: 62.0-65.0 wt. % mineral oil, 27.0-28.0 wt. % emulsifiers, and 8.0-10.0 wt. % water; preferably, 63.5-64.0 wt. % mineral oil, 27.5-28.0 wt. % emulsifier, 8.3-8.5 wt. % water. In some embodiments, the emulsifier mixture consists of (it being understood that some water is included in these materials but is not included herein): 50.0-52.0 wt. % sorbitan monolaurate and 48.0-50.0 wt. % POE (20) sorbitan monolaurate; preferably 50.5-51.5 wt. % sorbitan monolaurate and 48.5-49.5 wt. % POE (20) sorbitan monolaurate; and most preferably, 50.9-51.4 wt. % sorbitan monolaurate and 49.6-49.1 wt. % POE (20) sorbitan monolaurate. The lubricant is then mixed with water (e.g., de-ionized or de-mineralized water) to form a 3-15 wt. % water emulsion, for example. In some embodiments, the water emulsion is added on to the tow to obtain a final range from 0.7-1.8 wt. % FOY (i.e., after the dryer), preferably about 1.0 wt. % FOY (FOY is finish on yarn and represents the lubricant less added water).

### Plasticizer

In some embodiments, after the fibers are bundled into a tow and before the tow enters the crimper, the tow is plasticized at the plasticizing station 112. The plasticizing station 112 can be adjustable up and down and from side to side, so that the tow properly enters crimper 114 as will be more apparent in the discussion of the crimper below. The plasticizing station 112 can be spaced away from crimper 114, for example. Plasticizing station 112 can be placed before the crimper 114, so that the plasticizer added to the tow has a sufficient time to plasticize the tow. Preferably, plasticizer station 112 is at least one half (½) meter before the crimper nip, more preferably one meter before the crimper nip. The plasticizer station 112 adds a plasticizer, preferably water, most preferably de-mineralized water, to the tow. In some embodiments, the plasticizer is applied at a maximum rate to a point of excess spray-back from the crimper nip rolls. The application rate is preferably less than 300 cc/min at line speeds of 200-1,000 meters per minute with a tow of 10,000-100,000 total denier, most preferably 25-200 cc/min at line speeds of 200-1,000 meters per minute with a tow of 10,000-100,000 total denier. The applicator is preferably a “spool” type guide(s) adapted to deliver the plasticizer. Preferably, a pair of spool guides is used to insure proper wetting of both sides of the tow. In some embodiments, the spool guides may be spaced apart so that the tow runs therebetween in a straight line or the spool guides may be closely spaced so that the tow runs therebetween in an “S” shaped path. The surface of the spool guides may be flat or curved (e.g., concave, convex, wavy, or concaved/convexed). The spool guide may be made of ceramic material or ceramic coated, for example. The spool guide may be flanged or flangeless, for example. In some embodiments, the spool guide may have a plurality of openings through which the plasticizer is applied to the tow.

### Stuffer Box Crimper

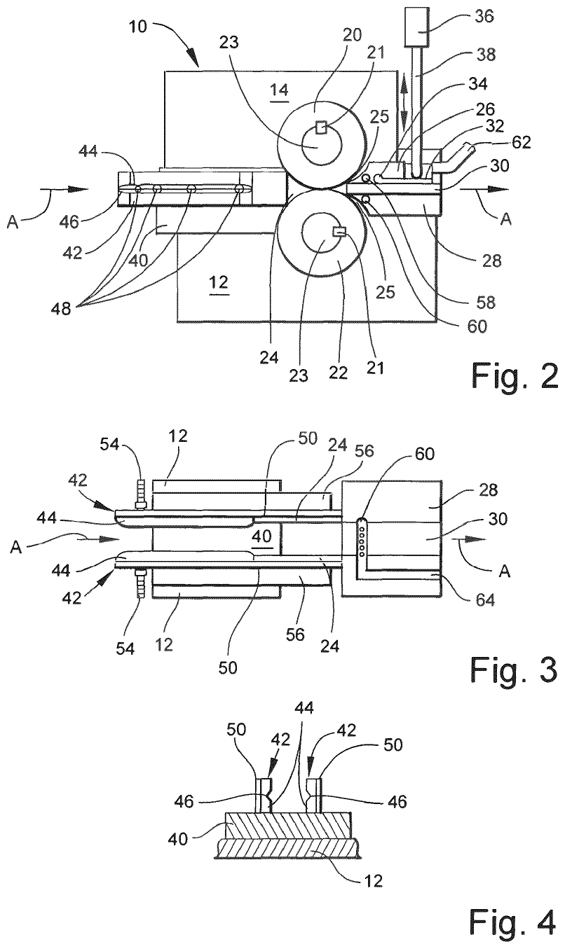

In the embodiment of FIG. 2, there is shown a stuffer box crimper 10. Crimper 10 has a base frame 12 and a top frame 14. Base frame 12 and top frame 14 are joined together, so that top frame 14 may move (or “float”) in relation to base frame 12. The tow travels through the crimper as indicated by arrows A.

In some embodiments, tow, not shown, is pulled through the crimper 10 by a pair of driven nip rollers 20, 22 that are mounted on shafts 23 and fixed in place via keys 21. Upper nip roller 20 is mounted on the top frame 14. Lower nip roller 22 is mounted on base frame 12. Shafts 23 are coupled to motors (not shown). The tow leaves the nip rollers 20, 22 and enters the stuffer box having a channel 30 and a flapper 32 located at the distal end of the channel 30. In the channel 30, the tow is folded perpendicular to its direction of travel as it encounters backpressure caused by the tow being shoved (or stuffed) into the channel 30 against the flapper 32. This folding creates the crimp in the tow.

Nip rolls 20, 22, are referred to as “induced crimp” rolls. The induced crimp rolls crease (or bend) the tow as it passes through the nip and thereby “trains” the tow where to crimp (e.g., influences the location of crimp in the tow by preferentially weakening areas of the tow to be crimped).

While in some embodiments, the induced crimp rolls be the nip rolls of the crimper, the invention is not so limited. The induced crimp rolls may be another pair of rollers located before the crimper 10. Also, the induced crimp rolls grip the tow thereby preventing slippage.

Either or both (or neither) nip rolls may be an “induced crimp roll.” One nip roll may have a smooth circumferential surface and the other may have an axially grooved circumferential surface, both rolls may have an axially grooved circumferential surface, or both rolls may have a smooth circumferential surface, for example. In a preferred embodiment, both rolls have a smooth circumferential surface. The axially grooved roll creases the tow and thereby trains it to crimp in a uniform manner. In embodiments where present, the grooved roll may be located either on the top or bottom of the pair, but it is preferred at the bottom.

The term “grooved” refers to any surface texturing that will “induce” crimp. Such surface texturing may include grooves, dimples, or other types of texturing. A surface having grooves is preferred. The grooves are preferably in the form of a sine curve, but may also be rectangular, triangular, or semicircular notches, grooves, or ridges with or without flat surfaces therebetween that extend axially (i.e., lateral to lateral) across the face of the roller. In some embodiments, these grooves may range from 10 to 100 grooves per inch (2.5 cm), preferably 25 to 75 grooves per inch (2.5 cm), most preferably 50 grooves per inch (2.5 cm). The groove depth (peak to trough) may range from 0.5 mils to 5.0 mils (12.5 micron to 150 microns), preferably 1-2 mils (25-50 microns).

Upper nip roll 20, the smooth roll, may be made of metallic or ceramic materials, for example. Those materials include, but are not limited to, steel/alloy bonded titanium carbides, tungsten carbides, hipped or unhipped MgO stabilized zirconia, or hipped or unhipped Yttria stabilized zirconia (YTZP) (“hipped” refers to hot isostatic pressing). In some embodiments, the surface finish (texture) is no greater than 16 rms, with sharp lateral edges and free of chips.

Lower nip roll 22, the axially grooved roll, may be made of metallic or ceramic materials, for example. Those materials include, but are not limited to, steel/alloy bonded titanium carbides, tungsten carbides, hipped or unhipped MgO stabilized zirconia, or hipped or unhipped Yttria stabilized zirconia (YTZP). In some embodiments, the surface finish (texture) is no greater than 12 rms, with sharp lateral edges, rounded groove edges, and free of chips.

In an alternate embodiment of the invention, nip rolls 20, 22 are not the “induced crimp” rolls mentioned above (i.e., no axial grooves on either roll 20, 22). In this embodiment, the nip rolls 20, 22 are made of solid ceramic materials. This means that the roll is ceramic (i.e., not merely a coating). The ceramic materials include unhipped or hipped MgO stabilized zirconia, or hipped or unhipped Yttria stabilized zirconia (YTZP). In some embodiments, the surface finish (texture) is no greater than 16 rms, with sharp lateral edges and free of chips.

In the embodiment shown in FIG. 3, check plates 24 are located on both lateral sides of the nip rollers 20, 22 and abut the doctor blades 25. The check plates 24 are used to keep the tow in the nip between the nip rollers 20, 22. The cheek plates 24 may be made of metal, ceramic, or ceramic coated metal.

In an embodiment, the stuffer box has an upper half 26 affixed to the top frame 14 and a lower half 28 affixed to the base frame 12. The halves when mated define a stuffer box channel 30. A flapper 32 is located in the distal end of the channel. Flapper 32 is preferably mounted to upper half 26 via a pivot 34, so that flapper 32 may swing into channel 30 and partially close same. Movement of flapper 32 may be controlled by an apparatus capable of applying constant or variable pressure 36, such as (but not limited to) a voice coil actuator or a proportional valve controller, that can be operatively coupled to flapper 32 via rod 38.

### Apparatus for Applying Pressure (Constant or Variable)

In certain embodiments, the apparatus for applying pressure 36 can be a linear voice coil actuator that uses a bobbin and magnet assembly to provide linear force without contact between the moving and fixed world. The voice coil converts electrical signals directly into linear force. The polarity of the voltage can determine the translation direction of the motor. The magnet assembly can extend when current is applied, for example, thereby controlling the flapper position.

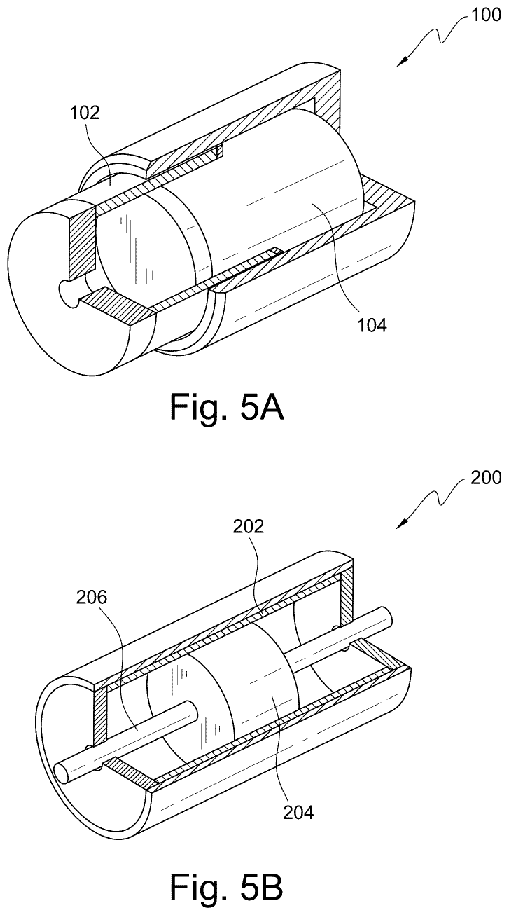

FIGS. 5A and 5B show two examples of a voice coil actuator 36. FIG. 5A shows an example of a moving coil actuator 100. The moving coil actuator 100 can comprise a coil 102 wound around a bobbin, which can be made from a non-magnetic material, for example. In this embodiment, the coil 102 can move in and out of a permanent magnetic field assembly 104. The magnetic field assembly 104 can comprise a steel housing with a concentric permanent magnetic assembly in the middle, for example. FIG. 5B shows an example of a moving magnet actuator 200. The moving magnet actuator 200 can comprise a permanent magnet field assembly piston 204 that moves inside a coil tube 202 (e.g., a cylindrical coil tube). The field assembly piston 204 can be attached to a shaft 206. The moving magnetic actuator 200 can have end caps containing bearings (e.g., integrated bearings) for example. In some embodiments, the current flowing through the coils (102, 202) interacts with the permanent magnetic field assembly (104, 204) and generate a force vector perpendicular to the direction of the current.

In some embodiments, the apparatus for applying pressure 36 can be a proportional valve controller. The proportional control valve can provide variable or constant hydraulic outputs proportional to an electric input signal in terms of pressure on the flapper 32, for example. This input signal can be either analog or digital and it determines how much pressure is required for the desired output. The electromagnetic output force of the solenoid of the valve controller is proportional to the current flowing through the coil of the controller. In some embodiments, the coil inside of the proportional control valve changes its shape when there is an electric current running through it, which then moves two plates inside the valve to allow more or less fluid through. In certain embodiments, the proportional valve can comprise an actuator and a two-port or three-port valve. The actuator can be a piston or diaphragm with a rod attached to it (e.g. rod 38), for example. In some embodiments, the rod is connected to a stem at one end and pivots in the center of the two-port or three-port. The proportional valve can be either directional or non-directional.

Flapper 32 movement in FIG. 3 can be controlled by the apparatus capable of applying constant or variable pressure 26 (e.g., a voice coil actuator or a proportional valve controller) to ensure uniformity of the crimp. In some embodiments, the apparatus capable of applying pressure 26 can completely control the pressure on the flapper 32. In other embodiments, the apparatus capable of applying pressure 26 can partially control the pressure on the flapper 32, for example aiding an air bellow system. In some embodiments, the apparatus capable of applying pressure 26 can exert a constant force on the flapper 32, and consequently, on the tow. In other embodiments, the apparatus capable of applying pressure 26 can vary the force (on the flapper) with time based on the output from the stuffer box channel 30. In some embodiments, the apparatus capable of applying pressure 26 can vary the force on the flapper 32 based on the output of an on-line measurement of the crimp level and/or the UCE (as discussed further below). The apparatus capable of applying pressure 26 allows for precise control of the pressure on the flapper, allowing for a more consistent and tailored crimp.

Doctor blades 25 can be an integral part of the upper half 26 and lower half 28 of the stuffer box, for example. Doctor blades 25 are located next to (e.g., with a clearance of about 1 mil (25 microns)) the nip rolls 20, 22, so that tow does not stick to the rolls and is directed into channel 30.

In certain embodiments, the edges of the tow are lubricated prior to entry into the stuffer box crimper 10. Lubrication is preferably added immediately prior to entry into the stuffer box crimper 10. Lubrication is most preferably added to the tow edges immediately prior to the tow's entry into the nip between rolls 20, 22. This edge lubrication can minimize filament damage between the nip rolls and the cheeks plates. This edge lubricating system can be mounted on an alignment base 40 which is attached to base frame 12, for example. In the embodiments shown in FIG. 3, a fastening mechanism 56 allows the check plates 24 to be brought into position relative to the nip rolls 20, 22 (i.e., with shims and/or wedges). In the embodiments shown in FIG. 4, two edge lubrication applicators 42 are shown securely mounted onto base 40, so that when the tow enters the crimper 10, the edges of the tow may be lubricated with a suitable lubricant, such as water.

In some embodiments, dach edge lubrication applicator 42 comprises an applicator face 44 and backing plate 50. Backing plate 50 can be sufficiently long to support (i.e., extend behind) both the applicator face 44 and cheek plate 24 (FIG. 3). Applicator face 44 is affixed to backing plate 50, for example. The applicator face 44 is preferably flame spray ceramic coated to provide low friction and good wear. In some embodiments, check plate 24 is not affixed to plate 50, but instead is replaceably or removeably affixed. Applicator face 44 has a longitudinal groove 46, for example. Tow edges can be adapted to contact and run through the grooves 46 where they are lubricated. In some embodiments, dne or more orifices 48 (FIG. 2) are cut through applicator 42 and are in communication with grooves 46. The orifices 48 might be any number, size, or shape suitable to the task. The orifices 48 may be slots or circular holes. Preferably, the orifices 48 are round and of equal diameter. The diameter can be optimized for best distribution, for example, preferably equal to the height of the tow. In some embodiments, tnlets 54 supply the lubricant to applicators 42. The rate of lubricant addition via the applicator can vary depending upon numerous factors, including but not limited to, tow speed, tow size (total denier), filament size (dpf), and cross-sectional shape to mention but a few. In some embodiments, lubricant is added to below a maximum rate, the maximum rate reached when either the tow line flutters or there is excessive sprayback from the crimper. In some embodiments, the lubricant addition rate is less than 100 cc per minute per side, preferably less than 50 cc per minute per side, and most preferably between 10-50 cc/min/side.

Further, some embodiments may involve heating the tow bands before, after, and/or during crimping. While said heating may be used in conjunction with any crimp configuration, it may be advantageous to use said heating with a vertical and/or substantially vertical crimp configuration. Said heating may involve exposing the filaments of the tow band to steam, aerosolized compounds (e.g., plasticizers), liquids, heated fluids, direct heat sources, indirect heat sources, irradiation sources that causes additives in the filaments (e.g., nanoparticles) to produce heat, or any combination thereof.

Some embodiments may include conditioning the crimped tow band. Conditioning may be used to achieve a crimped tow band having a residual acetone content of about 0.5% or less w/w of the crimped tow band. Conditioning may be used to achieve a crimped tow band having a residual water content of about 8% or less w/w of the crimped tow band. Conditioning may involve exposing the filaments of the crimped tow band to steam, aerosolized compounds (e.g., plasticizers), liquids, heated fluids, direct heat sources, indirect heat sources, irradiation sources that causes additives in the filaments (e.g., nanoparticles) to produce heat, or any combination thereof.

In some embodiments, the crimp level and/or uncrimp energy measurement methods described herein can be carried out after the crimping, conditioning, and/or drying of the tow band. In some embodiments, the method is performed immediately after the tow exits the drier. In some embodiments, the method is performed at the last possible point in the production process. In some embodiments, the crimp level and/or the uncrimp energy measurement can be carried out before baling the tow. The crimp level and/or the UCE measurement can occur at any practicable point in the process, however.

### On-Line Crimp Measurement

In some embodiments, the on-line method for measuring the crimp level and/or UCE can comprise illuminating the tow band with at least one light. In some embodiments, the light can be a visible light. Thus, in some embodiments, the light can be a red, orange, yellow, green, blue, indigo, or a violet light, or combinations thereof. In other embodiments, the light is not a visible light, such as an infrared or ultraviolet light, for example. In some embodiments, the light can be other than the ambient light source (e.g., a light different from the normal room lighting). However, in some embodiments, the light source can be the ambient light.

In some embodiments, the method for measuring the crimp level and/or the uncrimp energy of the tow further comprises capturing at least one image of the light illuminating and/or reflecting off the tow band, for example by using at least one camera, e.g., a digital camera. Some embodiments can involve more than one camera, e.g., 2 cameras, at least 2 cameras, 3 cameras, at least 3 cameras, 4 cameras, at least 4 cameras, 5 cameras, at least 5 cameras, 6 cameras, at least 6 cameras, 7 cameras, at least 7 cameras, 8 cameras, or at least 8 cameras. In some embodiments, the at least one camera is monochromatic. In other embodiments, the at least one camera is polychromatic. In some embodiments, the at least one camera can be a stationary camera. In other embodiments, the at least one camera can be a moving camera, e.g., the camera can be repositioned as needed. In some embodiments, the at least one camera can be a DSLR camera, a mirror-less camera, a point-and-shoot camera, a bridge camera, or a compact camera. In some embodiments, the at least one camera can take still images. In other embodiments, the at least one camera can take video images (e.g., continuous images).

In some embodiments, the method for measuring the crimp level and/or the uncrimp energy of the tow further involves analyzing the at least one image, for example, analyzing the at least one image for the number of waves and/or crimps (e.g., primary crimp, secondary crimp, etc.) in an image and/or length of tow. The inventors surprisingly found that the number of waves and/or crimps in a defined section of tow can be used to determine a crimp level and/or correlated to UCE. Thus, the crimp level in a tow can be visually detected and, if desired, correlated to UCE. In this way, the UCE of a tow can be measured indirectly within the usage of this disclosure. In some situations, the number of waves and/or crimps can be visible to the naked eye. In other situations, the waves and/or crimps may not be visible to the naked eye. In some embodiments, analyzing the image for waves and/or crimps is carried out using computer software (e.g., a computer program). In some embodiments, the analysis of the image can involve scanning the image for indications of waves and/or crimps. In some embodiments, the analysis of the image can comprise isolating the color channel of the image, e.g. isolating the red channel of the image. In some embodiments, the analysis can involve an on-line evaluation of the tow to compare it to stored (reference) specifications and/or parameters.

In some embodiments, the method of measuring the crimp level and/or the uncrimp energy of the tow can monitor the crimp level and/or UCE of the tow 100 percent of the time (or substantially 100 percent of time) during tow production. In other embodiments, the method can be used intermittently during tow production (e.g., 95 percent of the time, 90 percent of the time, 80 percent of the time, 75 percent of the time, 70 percent of the time, 60 percent of the time, 50 percent of the time, 40 percent of the time, 35 percent of the time, 30 percent of the time, 25 percent of the time, 20 percent of the time, 15 percent of the time, 10 percent of the time, 5 percent of the time, or 1 percent of the time).

In some embodiments, the output of the on-line measurement of crimp level and/or the UCE described can be used to control or change the actuator 36 to adjust the force on the flapper 32 of the stuffer box channel 30. For example, when the crimp level and/or the UCE of the tow deviates from a specified range according to the on-line measurement, the force on the flapper 32 can be increased or decreased by the actuator to increase or decrease the crimp level and/or the UCE of the tow to correct it to within the specified range. In some embodiments, the online crimp level and/or UCE measurement is coupled with the flapper actuator 36 in a feedback control loop. In other embodiments, the flapper actuator 36 is adjusted manually based on the online crimp level and/or UCE measurement.

### Baling

After measuring the crimp level and/or the uncrimp energy of the tow, some embodiments of the present invention may include baling the crimped tow band to produce a bale. In some embodiments, baling may involve placing, e.g., laying, depositing, or arranging, the crimped tow band in a can in a pattern. It should be noted that can is used generically to refer to a container that may be in any shape, preferably square or rectangle, and of any material. As used herein, the term “pattern” refers to any design which may or may not change during placing. In some embodiments of the present invention, the pattern may be substantially zig-zag having a periodicity of about 0.5 cycles/ft to about 6 cycles/ft. In some embodiments, placing may involve puddling the crimped tow band with a puddling index of about 10 m/m to about 40 m/m. As used herein, the term “puddling” refers to allowing the tow band to lay at least partially on itself so as to place a greater actual length of tow band than linear distance on which it is placed. As used herein, the term “puddling index” refers to the length of tow band per linear distance on which it is placed.

In some embodiments of the present invention, baling may involve compressing the crimped tow band that has been placed in a suitable container. In some embodiments, baling may involve packaging the compressed crimped tow band. In some embodiments, the packaging may include at least one component like wrapping materials, vacuum ports (for releasing and/or pulling vacuum), securing elements, or any combination thereof. Suitable wrapping materials may include, but not be limited to, air-permeable materials, air-impermeable materials, films (e.g., polymeric films, polyethylene films, plastic wrap), heat-shrinkable films, cardboard, wood, woven materials (i.e., fabric composed of two sets of yarns interlaced with each other to form the fabric), non-woven materials (i.e., assemblies of textile fibers held together by mechanical or chemical means in a random web or mat, e.g., fused thermoplastic fibers), foil materials (e.g., metallic materials), and the like, or any combination thereof. Suitable securing elements may include, but not be limited to, VELCRO®, pins, hooks, straps (e.g., woven, non-woven, fabric, and/or metallic), adhesives, tapes, melt bondings, and the like, or any combination thereof. In some embodiments, at least a portion of the packaging (including any component thereof) may be reusable.

In some embodiments, bales may have dimensions ranging from about 30 inches (76 cm) to about 60 inches (152 cm) in height, about 46 inches (117 cm) to about 56 inches (142 cm) in length, and about 35 inches (89 cm) to about 45 inches (114 cm) in width. In some embodiments, bales may range in weight from 900 pounds (408 kg) to 2100 pounds (953 kg). In some embodiments, bales may have a density greater than about 300 kg/m³ (18.8 lb/ft³).

### Illustrations

Illustration 1: A method for measuring the crimp level and/or the uncrimp energy for a tow, the method comprising: providing a tow band; illuminating the tow band with at least one light; capturing at least one image of the light reflecting off the tow band; and analyzing the image to determine the crimp level and/or the uncrimp energy for the tow band.

Illustration 2: The method of illustration 1, wherein the tow band comprises cellulose acetate.

Illustration 3: The method of illustrations 1 or 2, wherein the at least one light is a visible light.

Illustration 4: The method of any of the preceding illustrations, wherein the capture of the image is performed with a camera.

Illustration 5: The method of any of the preceding illustrations, wherein the image is analyzed using computer software.

Illustration 6: The method of any of the preceding illustrations, wherein analyzing the image comprises isolating the color channel of the image.

Illustration 7: The method of any of the preceding illustrations, wherein the method is carried out automatically at a predetermined time.

Illustration 8: The method of any of the preceding illustrations, wherein the method is carried out after the tow band has undergone drying.

Illustration 9: The method of any of the preceding illustrations, wherein the method is carried out before the tow band has been formed into layers or bales.

Illustration 10: The method of any of the preceding illustrations, wherein the source of the at least one light is at a distance of less than 20 meters from the tow band.

Illustration 11: A process for making a cellulose acetate tow comprising the steps of: spinning a dope comprising a solution of cellulose acetate and a solvent, taking-up the as-spun cellulose acetate filaments, forming a tow from the cellulose acetate filaments, plasticizing the tow, crimping the plasticized tow using a flapper controlled by a voice coil actuator, drying the crimped tow, and baling the dried crimped tow.

Illustration 12: The process of illustration 11, further comprising applying a constant force on the tow using the voice coil actuator acting on the flapper.

Illustration 13: The process of illustration 11 or 12, further comprising applying a force on the tow that is varied over time using the voice coil actuator acting on the flapper.

Illustration 14: The process of any of illustrations 11-13, further comprising adjusting the voice coil actuator based on the results of the measurement of the crimp level and/or the uncrimp energy.

Illustration 15: The process of any of illustrations 11-14, further comprising measuring the crimp level and/or the uncrimp energy of the dried tow after drying the crimped tow.

Illustration 16: The process of any of illustrations 11-15, wherein measuring the crimp level and/or the uncrimp energy of the dried tow comprises: illuminating the dried tow with a light at a predetermined angle to the tow band; capturing an image of the light contacting the tow band; and analyzing the image to determine the crimp level and/or the uncrimp energy for the tow band.

Illustration 17: The process of any of illustrations 11-16, wherein measuring the crimp level and/or the uncrimp energy of the dried tow is performed continuously.

Illustration 18: The process of illustrations 16 or 17, wherein analyzing the image comprises isolating the color channel of the image using computer software.

Illustration 19: The process of any of illustrations 11-18, wherein the cellulose acetate tow has a more uniform crimp level and/or the uncrimp energy compared to cellulose acetate tow producing using conventional methods.

While the invention has been described in detail, modifications within the spirit and scope of the invention will be readily apparent to those of skill in the art. It should be understood that aspects of the invention and portions of various embodiments and various features recited above and/or in the appended claims may be combined or interchanged either in whole or in part. In the foregoing descriptions of the various embodiments, those embodiments which refer to another embodiment may be appropriately combined with other embodiments as will be appreciated by one of ordinary skill in the art. Furthermore, those of ordinary skill in the art will appreciate that the foregoing description is by way of example only and is not intended to limit the invention. All US patents and publications cited herein are incorporated by reference in their entirety.

We claim:

1. A method for measuring the crimp level or the uncrimp energy for a tow, the method comprising:
a) providing a tow band;
b) illuminating the tow band with at least one light;
c) capturing at least one image of the light reflecting off the tow band; and
d) analyzing the image to determine the crimp level or the uncrimp energy for the tow band.

2. The method of claim 1, wherein the tow band comprises cellulose acetate.

3. The method of claim 1, wherein the light is a visible light.

4. The method of claim 1, wherein the capture of the image is performed with a camera.

5. The method of claim 1, wherein the image is analyzed using computer software.

6. The method of claim 1, wherein analyzing the image comprises isolating the color channel of the image.

7. The method of claim 1, wherein the method is carried out automatically at a predetermined time.

8. The method of claim 1, wherein the method is carried out after the tow band has undergone drying.

9. The method of claim 1, wherein the method is carried out before the tow band has been formed into layers or bales.

10. The method of claim 1, wherein the source of the at least one light is at a distance of less than 20 meters from the tow band.

11. A process for making a cellulose acetate tow comprising the steps of:
spinning a dope comprising a solution of cellulose acetate and solvent to produce as-spun cellulose acetate filaments;
taking-up the as-spun cellulose acetate filaments;
forming a tow from the cellulose acetate filaments;
plasticizing the tow;
crimping the plasticized tow using a flapper controlled by an apparatus capable of applying pressure;
drying the crimped tow;
baling the dried crimped tow.

12. The process of claims 11, further comprising applying a constant force on the tow using the apparatus capable of applying pressure acting on the flapper.

13. The process of claim 11, further comprising applying a force on the tow that is varied over time using the apparatus capable of applying pressure acting on the flapper.

14. The process of claim 11, further comprising adjusting the apparatus capable of applying pressure based on the results of the measurement of the crimp level or the uncrimp energy.

15. The process of claim 11, further comprising measuring the crimp level or the uncrimp energy of the dried tow after drying the crimped tow.

16. The process of claim 15, wherein measuring the crimp level or the uncrimp energy of the dried tow comprises:
illuminating the dried tow with a light at a predetermined angle to the tow band;
capturing an image of the at least on light illuminating the tow band; and
analyzing the image to determine the crimp level or the uncrimp energy for the tow band.

17. The process of claim 15, wherein measuring the crimp level or the uncrimp energy of the dried tow is performed continuously.

18. The process of claim 16, wherein analyzing the image comprises isolating the color channel of the image using computer software.

19. The process of claim 11. wherein the cellulose acetate tow produced has a more uniform crimp level or uncrimp energy compared to cellulose acetate tow producing using conventional methods.

20. The process of claims 11. wherein the apparatus capable of applying pressure is a voice coil actuator.
